(19) United States
(12) Patent Application Publication
(10) Pub. No.: US 2012/0061632 A1
(43) Pub. Date: Mar. 15, 2012

(54) Hydraulic Lifting Apparatus

(76) Inventor: Michael T. Panio, Whitestone, NY (US)

(21) Appl. No.: 12/880,824

(22) Filed: Sep. 13, 2010

(51) Int. Cl. B66F 11/00; B23P 17/00

(52) U.S. Cl. 254/133 R; 29/426.1

(57) ABSTRACT

The invention provides a hydraulic lifting apparatus that permits convenient and efficient removal and replacement of a rectangular manhole cover from an access conduit. The invention further allows personnel to perform such removal and replacement from a safe distance. In one embodiment, the hydraulic lifting apparatus comprises a lifting member coupled to a hydraulic actuation device that is movably connected to lifting hooks to permit interface with and release from the lifting blocks of the rectangular manhole cover.

### FIELD OF THE INVENTION

The invention relates in general to a hydraulic lifting apparatus and, more particularly, to a hydraulic lifting apparatus used to lift rectangular manhole covers, street gratings, and the like.

### BACKGROUND

Underground utility installations (such as sewer pipes, electrical cable conduits, and the like) have become increasingly complex. This increasing complexity often requires frequent access by construction or maintenance personnel in order to install new utilities or upgrade and maintain existing utilities. Since these utility installations are located underground, access to them is generally accomplished through an entrance hole set at ground level. Personnel typically descend through the entrance hole into a vertical access conduit that permits access to the utility installations. These access conduits are commonly referred to as “manholes”.

The entrance hole of the access conduit is usually closed with some type of cover, such as a manhole cover or grating. These manhole covers can be of different shapes and sizes (circular, rectangular, etc.) depending upon the degree of access required or the type of access conduit that is in use. To ensure safety, security, and durability, manhole covers are typically constructed of a rigid material, such as cast iron. As a result, the manhole covers can be very heavy and difficult to lift, and may pose a safety risk to personnel who attempt to remove a manhole cover for entry into an access conduit.

Various types of equipment and techniques have previously been devised to assist personnel with the task of safely lifting various types of manhole covers, including rectangular manhole covers. Many of these techniques and equipment involve the use of levers, pulleys, and the like, to provide the mechanical advantage necessary to remove a heavy manhole cover from the top of an access conduit. Existing equipment and techniques therefore allow a small number of personnel, and even an individual, to remove the manhole cover.

Existing equipment and techniques, however, still require that considerable effort be expended by personnel to remove the manhole cover and that personnel remain in close proximity to the access conduit when the manhole cover is being removed. Under some circumstances, conditions may arise that make manhole cover removal very dangerous. For example, there may be a build up of gas within the access conduit. Removal of the manhole cover may cause ignition of the gas, resulting in an explosion. Any personnel who are in close proximity to the access conduit therefore face severe danger and the possibility of extreme injury. Accordingly, there is a need for an apparatus that provides efficient and convenient manhole cover removal and replacement and at the same time keeps personnel safe by allowing such removal and replacement to be performed by personnel from a sufficient distance from the manhole cover and access conduit. In particular, there is a need for an apparatus that may be used to remove and replace rectangular manhole covers.

### SUMMARY OF THE INVENTION

The invention described herein is intended to addresses the above needs. In particular, it is an objective of the invention to provide an apparatus that facilitates the efficient and convenient removal and replacement of rectangular manhole covers. Another objective of the invention is to permit personnel to safely perform such removal and replacement from a sufficient distance from the rectangular manhole cover and the access conduit.

To achieve these and other objectives, the invention provides a hydraulic lifting apparatus that permits safe and convenient removal and replacement of a rectangular manhole cover. An embodiment of the invention provides a lifting member operably connected to a hydraulic actuation device and a plurality of lifting hooks. The hydraulic lifting device may be configured to be lifted by appropriate rigging equipment, such as a crane, and the hydraulic actuation device may be activated by personnel from a location that is not in close proximity to the rectangular manhole cover and access conduit. In operation, one embodiment of the invention provides for the activation of the hydraulic actuation device that causes the plurality of lifting hooks to securely interface with lifting blocks that are provided on the rectangular manhole cover. After the lifting hooks are securely interfaced with the lifting blocks, the hydraulic lifting apparatus and the rectangular manhole cover may be lifted by an appropriate rigging structure. When the rectangular manhole cover is replaced, the hydraulic actuation device may be de-activated to allow release of the lifting hooks from the lifting blocks of the rectangular manhole cover.

### BRIEF DESCRIPTION OF THE DRAWINGS

The features, objects, and advantages of the inventions of this invention will become more apparent from the detailed description set forth below when taken in conjunction with the drawings in which like reference characters identify correspondingly throughout and wherein:

FIG. 1 is a side view of a hydraulic lifting apparatus in accordance with one embodiment of the invention;

FIG. 2 is a top view of the hydraulic lifting apparatus shown in FIG. 1;

FIG. 3 is a sectional view of the hydraulic lifting apparatus shown in FIG. 2, taken along line A-A;

FIG. 4 is a top view of one type of rectangular manhole cover with which a hydraulic lifting apparatus in accordance with one embodiment of the invention may be used.

### DETAILED DESCRIPTION OF EXEMPLARY EMBODIMENTS

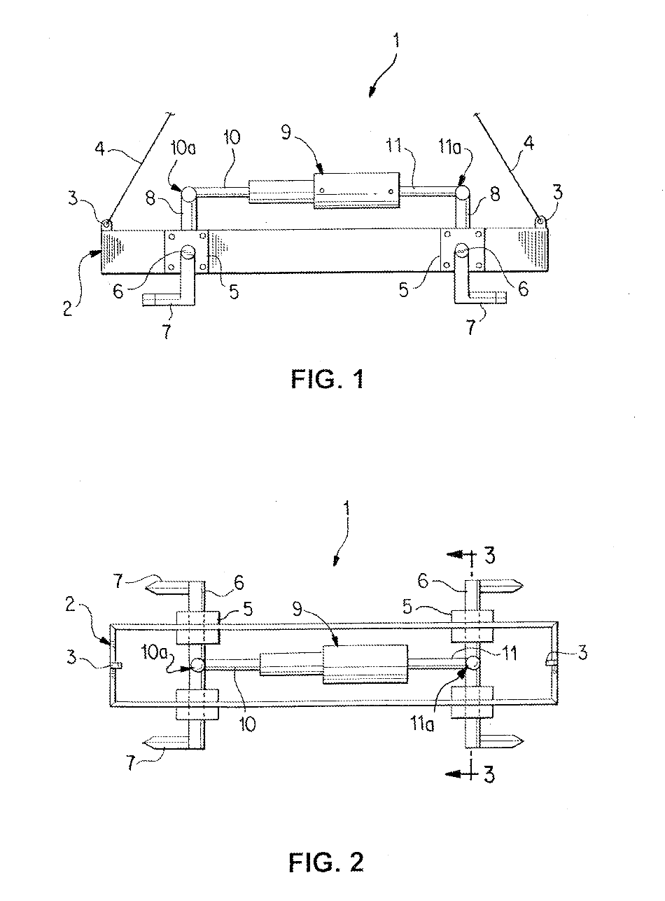

A hydraulic lifting apparatus 1 in accordance with one embodiment of the invention is shown in FIGS. 1 and 2. Hydraulic lifting apparatus 1 includes a lifting member 2. Lifting member 2 may be of any suitable construction. In the embodiment of the hydraulic lifting apparatus 1 shown in FIGS. 1 and 2, the lifting member 2 has an elongated box-type structure, constructed of four steel plates fastened together in a suitable fashion, for example, by welding. Alternatively, lifting member 2 could be constructed of a frame that includes tubular members. Lifting member 2 preferably includes a plurality of lifting points 3 to which an appropriate rigging structure may be affixed in order to lift the complete hydraulic lifting apparatus 1 with rigging or lifting equipment, such as, a crane. For example, rigging lines 4 may be attached to lifting points 3. Rigging lines 4 may be constructed of steel wire, chain, or any other suitable material known in the art.

Fastened to the lifting member 2 are a plurality of bearing plates 5. Bearing plates 5 may be fastened to lifting member 2 with bolts (as shown), by welding, or may be integral with the steel plates that form the lifting member 2. As shown in FIG. 2, rods 6 are positioned through holes in the bearing plates 5 and corresponding holes of the steel plates that form the long sides of lifting member 2. Appropriate means (not shown) to secure the rods 6 in the axial direction may be incorporated as is well known in the art. Rods 6 may be of any suitable cross-sectional shape, such as, for example, round, square, or hexagonal.

Affixed to the rods 6 in a suitable fashion, such as, for example, by welding, are a plurality of lifting hooks 7 that may extend in the downward direction (e.g., towards the ground). Alternatively, lifting hooks 7 may removable from the rods 6 in a manner that permits disconnection and replacement with either a new lifting hook 7 of the same type, or a hook of a different type, depending upon the size of the rectangular manhole cover being lifted by the hydraulic lifting apparatus 1 or the particular location and structure of pockets 13 and lifting blocks 14 that are integral with the rectangular manhole cover, as shown, for example, on rectangular manhole cover 12 in FIG. 4. Lifting hooks 7 may be affixed to the ends of rods 6, or may be affixed at a position offset from the ends, towards the center of rods 6.

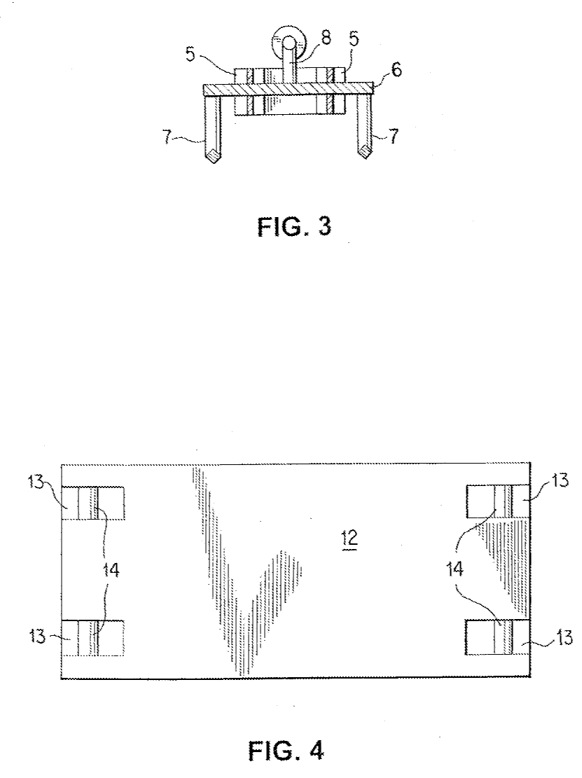

As shown in FIGS. 1 and 3, arms 8 are affixed to the rods 6 in a suitable fashion, such as, for example, by welding. Arms 8 may extend from rods 6 in the upward direction (e.g., away from the ground). As shown in FIGS. 1 and 2, the hydraulic lifting apparatus 1 includes a hydraulic actuation device. Hydraulic actuation device includes a hydraulic piston 9 with actuation members 10 and 11. In accordance with an embodiment of the invention, hydraulic actuation device may be operated by personnel from an appropriate distance by suitable connections and control equipment (not shown) as are known in the art. Activation of the hydraulic piston 9 causes actuation members 10 and 11 to translate in a manner such that the ends of actuation members 10 and 11, 10a and 11a, respectively, move towards one another. The ends 10a and 11a of actuation members 10 and 11 are coupled to the top end of arms 8, as shown. Preferably, the coupling of ends 10a and 11a to arms 8 may be disengaged, to allow for maintenance and/or replacement of hydraulic activation device, or any of its component parts.

FIG. 4 shows one type of rectangular manhole cover used to cover an access conduit that may be lifted and replaced using an embodiment of the hydraulic lifting apparatus 1. Rectangular manhole cover 12 includes an interface structure. For example, the interface structure of rectangular manhole cover 12 may include a plurality of pockets 13. Integral with each pocket 13 is a lifting block 14 positioned such that lifting hook 7 may be inserted into the pocket 13 and under lifting block 14 to form an interface, or engagement, between the lifting hook 7 and the lifting block 14 and allow the rectangular manhole cover 12 to be lifted from the access conduit.

In operation, hydraulic lifting apparatus 1 is affixed to an appropriate rigging structure at lifting points 3 by rigging lines 4. Rigging lines 4 may be affixed to appropriate rigging or lifting equipment, such as a crane or similar device. The hydraulic lifting apparatus 1 is moved into a position over the rectangular manhole cover 12, and is lowered to allow lifting hooks 7 to be inserted into pockets 13. The hydraulic piston 9 is then activated by personnel from a remote location. As described above, activation of the hydraulic piston 9 causes ends 10a and 11a of actuation members 10 and 11 to move towards one another. Movement of ends 10a and 11a in this manner causes arms 8, rods 6, and lifting hooks 7 to rotate about the axis of rods 6. This rotation results in a secure interface between lifting hooks 7 and lifting blocks 14. After a secure interface is achieved, the hydraulic lifting device 1 and the rectangular manhole cover 12 may be lifted as one piece by suitable rigging equipment, removing rectangular manhole cover 12 from the top of the access conduit.

To replace the rectangular manhole cover 12 onto the top of the access conduit, the hydraulic lifting device 1 and rectangular manhole cover 12 are appropriately positioned over the access conduit, again using suitable rigging equipment. The hydraulic lifting device 1 and rectangular manhole cover 12 are then lowered such that rectangular manhole cover 12 is placed on top of the access conduit. Hydraulic piston 9 may then be de-actuated by personnel from a remote location such that ends 10a and 11a of actuation members 10 and 11 move away from one another. The movement of ends 10a and 11a in this manner causes arms 8, rods 6, and lifting hooks 7 to rotate about the axis of rods 6 in a rotational direction opposite from when the lifting hooks 7 of hydraulic lifting apparatus 1 are being securely interfaced with the lifting blocks 14 of the rectangular manhole cover 12. This opposite rotation results in the release of lifting hooks 7 from lifting blocks 14. After release, the hydraulic lifting apparatus 1 may be removed and the rectangular manhole cover 12 is securely replaced on the access conduit.

In view of the above description, it will be seen that the several objects of the invention are achieved and other advantageous results obtained. As various changes could be made to the embodiments described without departing from the scope of the invention, it is intended that all matter contained in the above description or shown in the accompanying drawings shall be interpreted as illustrative and not so as to limit the scope of the invention.

What is claimed is:

1. A hydraulic lifting apparatus operable to remove and replace a rectangular manhole cover from an access conduit, comprising:
a substantially elongate lifting member;
a bearing plate affixed to the lifting member;
a rod rotatable about its major axis, the rod axially fixed through a portion of the lifting member and the bearing plate;
a lifting hook affixed to the rod, the lifting hook extending in a first direction from the rod;
an arm affixed to the rod, the arm extending in a second direction from the rod; and
a hydraulic actuation device comprising a hydraulic piston and an end affixed to the arm;
wherein activation of the hydraulic actuation device rotates the lifting hook.

2. A lifting apparatus for engaging a rectangular manhole cover, comprising:
a lifting member;
rotatable lifting hooks attached to the lifting member;
an actuation device for rotating the lifting hooks;
wherein activation of the actuation device rotates at least one of the rotatable lifting hooks to engage the lifting apparatus to the rectangular manhole cover.

3. A lifting apparatus according to claim 2, wherein the lifting member is rectangular.

4. A lifting apparatus according to claim 3, wherein the lifting member is of an elongated box-type construction.

5. A lifting apparatus according to claim 2, wherein the lifting member comprises a frame of tubular members.

6. A lifting apparatus according to claim 2, wherein the lifting member includes bearing plates.

7. A lifting apparatus according to claim 2, wherein there are four rotatable lifting hooks.

8. A lifting apparatus according claim 6, wherein the lifting hooks are fixedly attached to rotatable rods.

9. A lifting apparatus according to claim 2, wherein the actuation device is hydraulic.

10. A lifting apparatus according to claim 5, wherein the hydraulic actuation member is attached to the rotatable rods by arms.

11. A method for removing a rectangular manhole cover from an access conduit, comprising:
providing a hydraulic lifting apparatus comprised of:
a substantially elongate lifting member;
a bearing plate affixed to the lifting member;
a rod rotatable about its major axis, the rod axially fixed through a portion of the lifting member and the bearing plate;
a lifting hook affixed to the rod, the lifting hook extending in a first direction from the rod;
an arm affixed to the rod, the arm extending in a second direction from the rod; and
a hydraulic actuation device comprising a hydraulic piston and an end affixed to the arm;
attaching the hydraulic lifting apparatus to a rigging line, the rigging line being further attached to lifting equipment;
lowering the hydraulic lifting apparatus over a rectangular manhole cover;
activating the hydraulic actuation device of the hydraulic lifting apparatus, wherein activation causes the lifting hook to engage an interface structure of the rectangular manhole cover; and
lifting the hydraulic lifting apparatus with the lifting equipment after the lifting hook is engaged to the interface structure of the rectangular manhole cover.

12. A method for removing a rectangular manhole cover from an access conduit according to claim 10, wherein there are four lifting hooks.

13. A method for removing a rectangular manhole cover from an access conduit according to claim 10, wherein the lifting equipment comprises a crane.

14. A method for removing a rectangular manhole cover from an access conduit according to claim 10, wherein the hydraulic actuation device is activated remotely.
